(19) United States
(12) Patent Application Publication
(10) Pub. No.: US 2014/0172476 A1
(43) Pub. Date: Jun. 19, 2014

(54) TECHNIQUES FOR GENERATING A HEAT MAP OF A RETAIL LOCATION

(71) Applicant: WAL-MART STORES, INC., Bentonville, AR (US)

(72) Inventor: Valerie Goulart, Seattle, WA (US)

(73) Assignee: Wal-Mart Stores, Inc., Bentonville, AR (US)

(21) Appl. No.: 13/714,931

(22) Filed: Dec. 14, 2012

(51) Int. Cl. G06Q 50/00

(52) U.S. Cl. CPC G06Q 50/00
USPC 705/7.11

(57) ABSTRACT

Methods and systems for generating a heat map for a retail location are disclosed herein. The method includes monitoring a plurality of regions of a retail location and determining a plurality of crowd sizes based on the monitoring. Each crowd size of the plurality of crowd sizes corresponds to one of the plurality of regions. Furthermore each crowd size may be indicative of an amount of people in its corresponding region at a given time. The method further includes generating a heat map based on the plurality of crowd sizes, the heat map being indicative of the amount of people in each of the regions. The heat map and crowd sizes can be used by a customer while shopping at the retail location, to optimize a shopping route of the customer, and/or to estimate wait times at particular regions of the retail location.

### BACKGROUND INFORMATION

1. Field of the Disclosure

The present invention relates generally to systems and methods for generating a heat map of a retail location.

2. Background

Many consumers visit supermarkets and superstores when shopping for products such as groceries, office supplies, and household wares. Typically, these stores can have dozens of aisles and/or sections. Accordingly, traversing these aisles looking for specific products may be a harrowing experience. Furthermore, certain regions of the store will randomly encounter crowding. For example, the deli counter may have no customers waiting for service, and in just a few minutes, the deli counter may have many customers in line. Similarly, a retail location may have 20 or more checkout stations. Some checkout stations may have long lines, while some checkout stations may have no lines, unbeknownst to those waiting in the longer lines.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic illustrating a heat map server in communication with a monitoring system that monitors a retail location according to some embodiments of the present disclosure;

FIG. 2 is a schematic illustrating example components of the heat map server of FIG. 1;

FIG. 3 is a schematic illustrating an example of a heat map according to some embodiments of the present disclosure; and

FIG. 4 is a flow chart illustrating an example method for generating a heat map according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In order to allow shoppers to be made aware of less crowded regions in a retail location, systems and methods are disclosed for generating a heat map for a retail location, where the heap map is indicative of the crowd sizes in each region of the retail location. As used herein, the term “heat map” can include any representation of a retail location that can convey crowd sizes corresponding to one or more regions of the retail location. The term “retail location” can include brick-and-mortar stores operated by a single retailer, e.g., supermarket or superstore, or a location that includes stores operated by multiple retailers, e.g., a shopping mall or a shopping plaza.

A heat map can be utilized to perform various tasks. For instance, the heat map may be used to determine an optimized route for a customer to follow when shopping for a list of products. In some embodiments, the heat map can be communicated to a mobile computing device of a customer of the retail location, such that the customer can determine which regions in the retail location have large crowd sizes at a given time. In this way, the customer can determine which checkout stations are more or less crowded, and what departments, e.g., deli or tire change station, have longer waits.

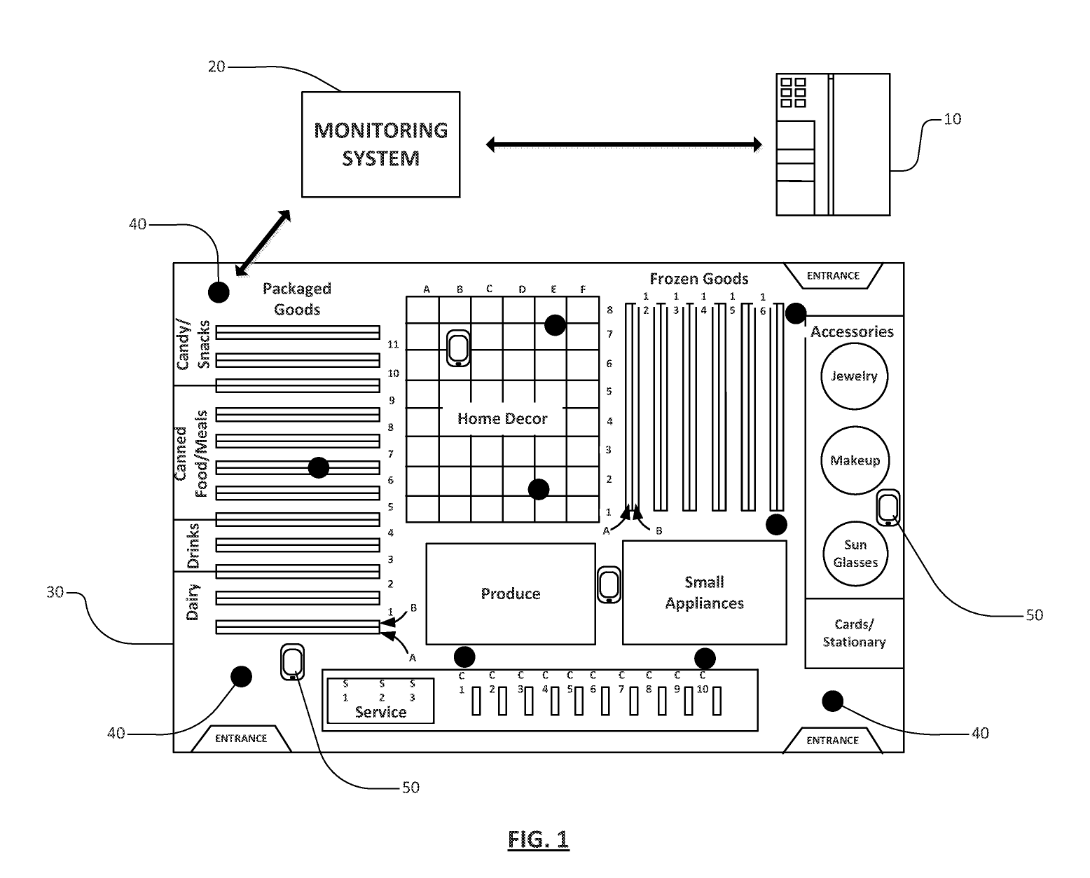

Referring now to FIG. 1, an example of a system for generating a heat map is disclosed. In some embodiments, the system includes a heat map server 10 and a monitoring system 20 that monitors a retail location 30. As used herein, the term “monitoring system” can include any combination of devices that monitor different regions of the retail location 30 to determine crowd sizes (or approximate crowd sizes) in each of the regions. The monitoring system 20 can provide raw data that is indicative of the crowd sizes in each region of retail location to the heat map server 10 and/or can process the raw data to determine the crowd sizes in each region and provide the crowd size to the heat map server 10. For purposes of explanation, the monitoring system is described as being configured to process the raw data to determine the crowd sizes in each region.

The exemplary retail store 30 illustrated in FIG. 1 can be arranged into different departments, such as packaged foods including dairy, drinks, canned foods/meals, and candy/snacksproduce; home decor; produce; frozen goods; small appliances; and accessories including jewelry, make-up, sunglasses, and cards/stationary. Each department can be further delineated. For example, the exemplary packaged goods area of the retail store 30 is subdivided into aisles 1-11 and each aisle can define an “a” side and a “b” side opposite the “a” side. The exemplary home decor area can be divided into a grid by letters A-F along a first edge and numbers 1-8 along a second edge perpendicular to the first edge. The illustrated, exemplary retail store 30 can also include one or more entrances, a service counter, and several checkout lines each referenced in FIG. 1 by the letter “c” and a number. It is noted that the arrangement of the retail store 30 is exemplary. In some embodiments of the present disclosure a retail store 30 can be arranged differently and include different departments and/or different products.

In some embodiments, the monitoring system 20 includes a plurality of sensors 40 dispersed throughout the retail location 30. It is noted that in FIG. 1 less than all of the sensors 40 are annotated to enhance the clarity of the figure but are illustrated identically. The plurality of sensors 40 can include video cameras and/or motion sensors. In these embodiments, the monitoring system 20 receives input from one or more sensors 40 in a particular region. For example, the input received by the monitoring system 20 can be a video feed from a video camera monitoring a particular region or a section of the particular region. It is noted that in FIG. 1 only one of the sensors 40 is shown communicating with monitoring system 20 to enhance the clarity of the figure, but all of the sensors 40 can communicate with the monitoring system 20 in some embodiments of the present disclosure. In some embodiments, the monitoring system 20 analyzes the input from the sensors 40 to determine the crowd sizes in each region of the store. As used herein, the term “crowd size” can be indicative of an amount or approximate amount of people in the region. The amount or approximate amount can be a number of people in the region, a population density, e.g., people per square foot, and/or a relative amount, e.g., heavily crowded or lightly crowded. In embodiments where the crowd size indicates a population density, the monitoring system 20 can approximate the amount of people in the region and divide the amount of people by the square footage of the region.

In some embodiments, the monitoring system 20 implements crowd sourcing techniques to determine the crowd sizes in each of regions in the retail location 30. In these embodiments, the monitoring system 20 can receive GPS coordinates from mobile computing devices 50, e.g., smart phones, of customers located within the retail location 30. For example, the retail location 30 may furnish a wireless network that allows the mobile computing devices 50. While a mobile computing device 50 is connected to the wireless network, the monitoring system 20 can request the location of mobile computing device 50 and the mobile computing device 50 can provide its location. Alternatively, the mobile computing device 50 can be configured to automatically report its location while traveling through the retail location 30. The monitoring system 20 receives the locations of each mobile computing device 50 in the retail location and, for each mobile computing device 50, determines a region of the mobile computing device 50. In this way, the monitoring system 20 can determine many mobile computing devices 50 are each region of the retail location 30 based on the reported locations, which is utilized to determine the crowd size in each region. Furthermore, the monitoring system 20 may be configured to extrapolate the crowd size of a particular region based on the amount of mobile computing devices 50 in the region. For example, if statistical data shows that one in four customers have mobile computing devices 50 that report their location, the monitoring system 20 may multiply the number of mobile computing devices 50 in a particular region by four to estimate the crowd size of the region. It should be appreciated that the monitoring system 20 may be configured to estimate the crowd sizes in any other suitable manner. It is noted that in FIG. 1 less than all of the mobile computing devices 50 are annotated to enhance the clarity of the figure but are illustrated identically.

While shown as being separate from the heat map server 10, in some embodiments, the monitoring system 20 can be implemented as part of the heat map server 10. In these embodiments, the heat map server 10 receives the input from the sensors 40 and/or the mobile computing devices 50.

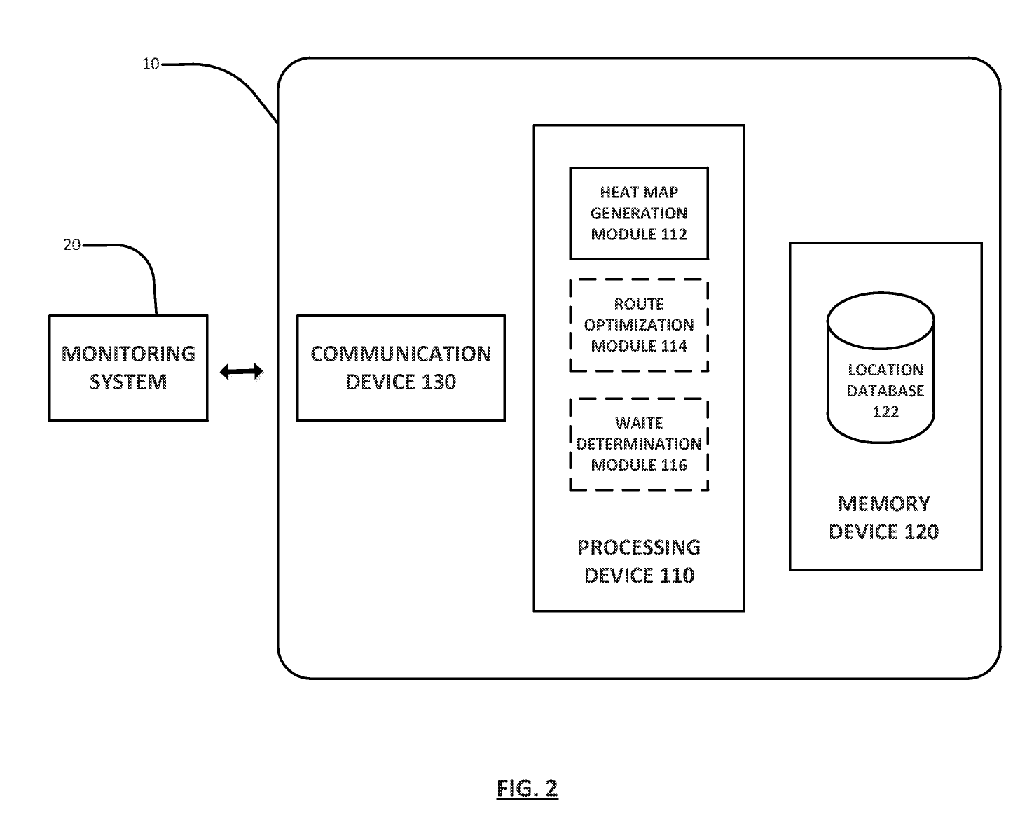

The heat map server 10 obtains the crowd sizes in each region of the retail location and generates a heat map based thereon. Referring now to FIG. 2, an example of the heat map server 10 is illustrated. In the illustrated example, the heat map server 10 includes, but is not limited to, a processing device 110, a memory device 120, and a communication device 130.

The communication device 130 is a device that allows the heat map server 10 to communicate with another device, e.g., the monitoring system 20, the sensors 40, and/or the mobile computing devices 50, via a communication network. The communication device 130 can include one or more wireless transceivers for performing wireless communication and/or one or more communication ports for performing wired communication.

The processing device 110 can include memory, e.g., read only memory (ROM) and random access memory (RAM), storing processor-executable instructions and one or more processors that execute the processor-executable instructions. In embodiments where the processing device 110 includes two or more processors, the processors can operate in a parallel or distributed manner. In the illustrative embodiment, the processing device 110 executes one or more of a heat map generation module 112, a route optimization module 114, and a wait determination module 116. Furthermore, in some embodiments, the processing device 110 can also execute the monitoring system 20 (FIG. 1) or components thereof.

The memory device 120 can be any device that stores data generated or received by the heat map server 10. The memory device 120 can include, but is not limited to a hard disc drive, an optical disc drive, and/or a flash memory drive. Further, the memory device 120 may be distributed and located at multiple locations. The memory device 120 is accessible to the processing device 110. In some embodiments, the memory device 120 stores a location database 122.

The location database 122 stores maps corresponding to different retail locations. Each map can be divided into a plurality of regions. A region can describe any type of boundary in the retail location. For instance, in the supermarket setting, a region can refer to a section, e.g., deli or frozen foods, one or more aisles, e.g., aisle 10, a checkout station, and/or a bank of checkout stations. In some embodiments, the regions may be defined by a collection of geospatial coordinates, e.g., GPS coordinates. Additionally, each map may have metadata associated therewith. The metadata for a map can include crowd size thresholds, which are described in further detail below. _Furthermore, for each retail location, the location database 122 may store product locations for the items sold at the retail location. Each item can have a GPS location or a relative location, e.g., GOLDEN GRAMS are located at aisle nine, 50 feet from the front of the aisle.

The heat map generation module 112 receives crowd sizes pertaining to the regions of a particular retail location and generates a heat map based thereon. The heat map generation module 112 can generate heat maps for each map stored in the location database 122 or can generate a heat map upon receiving a request for a heat map for a particular location from a requesting device, e.g., a mobile computing device, or a requesting process, e.g., a shopping route optimization process. For purposes of explanation, the description of the heat map generation module 112 assumes that the heat maps are generated in response to a request for a heat map for a particular location. It should be appreciated that the techniques described herein can be modified to generate heat maps for all of the retail locations in the locations database 112 at defined intervals, e.g., every 15 minutes.

The heat map generation module 112 can receive a request to generate a heat map for a particular retail location. In response to the request, the heat map generation module 112 retrieves a map corresponding to the particular retail location from the location database 122. Furthermore, the heat map generation module 112 can receive the crowd sizes for each region of the retail location from the monitoring system 20. For example, the heat map generation module 112 can receive inputs indicating (L, R, CS, T) from the monitoring system, where L is the retail location, R is a region of the retail location, CS is the crowd size in the region R, and T is the time at which the crowd size was determined. The heat map generation module 112 receives these inputs for each of the regions in the particular retail location.

Based on the received input, the heat map generation module 112 can annotate the retrieved map to indicate the crowd sizes in each region. In some embodiments, the heat map generation module 112 can determine a relative crowdedness for each region, e.g., empty, lightly crowded, moderately crowded, and heavily crowded, and congested. The heat map generation module 112 can determine the relative crowdedness of each region by comparing the crowd size of the region with one or more crowd size thresholds. In some embodiments, the crowd size thresholds for each region can be stored in the location database 122 in the metadata of the map of the retail location. Each crowd size threshold can correspond to a different relative crowdedness. For example, 0 people in the region can be classified as empty, less than 3 people in the region can be classified as lightly crowded, more than 3 and less than 10 people can be classified as moderately crowded, and more than 10 people in the region can be classified as heavily crowded. It should be appreciated that the crowd size thresholds can be set based on various considerations. For example, regions that tend to take longer to service a customer, e.g., deli counter or meat counter, may have lower thresholds than regions that do not require much time to service a customer, e.g., the produce region. Similarly, areas that are narrower, e.g., aisles, may have lower thresholds than areas that are more wide open, e.g., produce region.

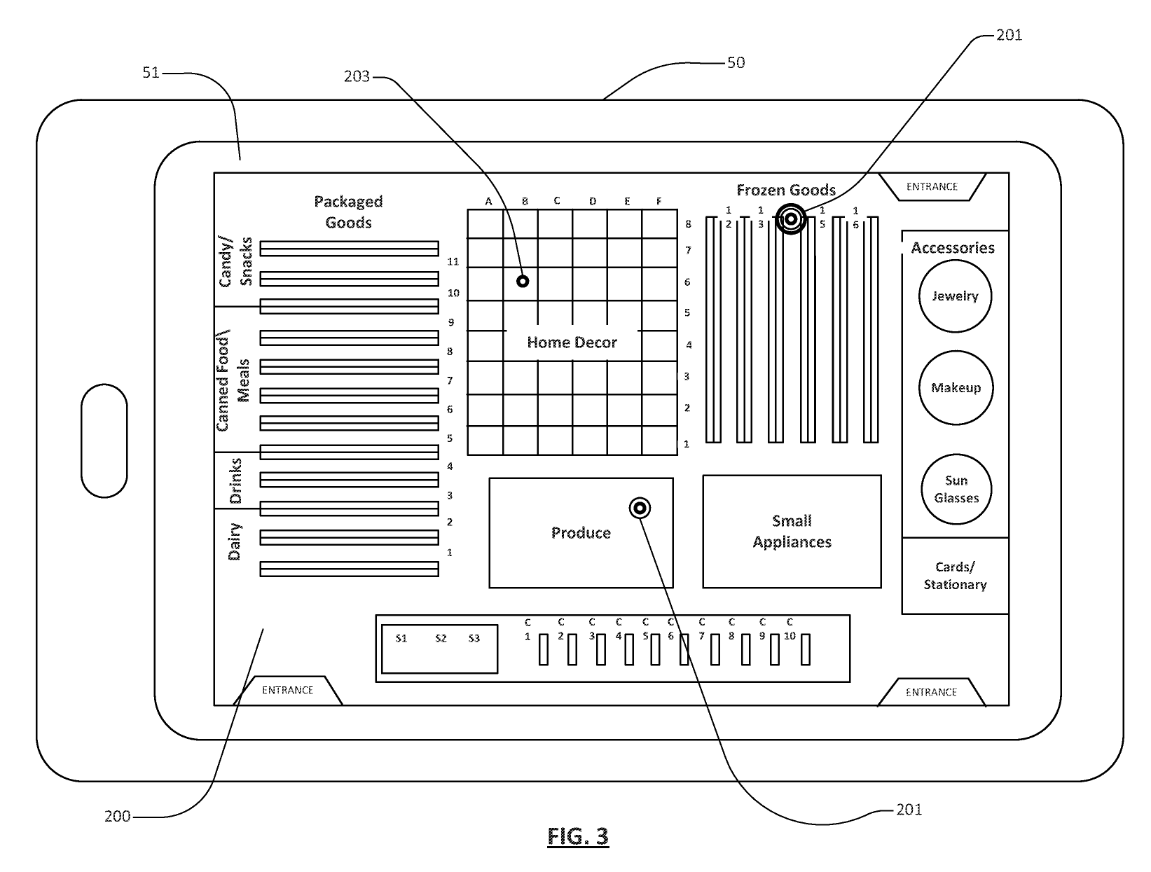

Once the heat map generation module 112 has determined the relative crowdedness of each region of the retail location, the heat map generation module 112 can annotate the map of the retail location to indicate the relative crowdedness in each of the locations. In some embodiments, the heap map generation module 112 can use a color scheme to indicate the relative crowdedness, e.g., no color=empty, green=lightly crowded, yellow=moderately crowded, and red=heavily crowded. In some embodiments, the heat map generation module 112 can annotate the map using symbols, patterns, or words to indicate the relative crowdedness of each region. For example, FIG. 3 illustrates an example of a heat map 200. In the illustrated example, the heat map 200 is a map of a retail location that has been annotated with words that indicate the relative crowdedness of the different regions of the retail location. For example, the “frozen goods” region is heavily crowded as indicated by visual indicia 201, the “candy and snacks” region has no crowd, and the “produce” region is moderately crowded as indicated by visual indicia 202, and the “home decor” region is lightly crowded as indicated by visual indicia 203. The visual indicia 201, 202, 203 can be colored differently from the remainder of the heat map 200 or can be flashing in order to be more easily located. While the example illustrates the heat map being annotated using words, it should be appreciated that the heat map can be annotated in any suitable manner, including but not limited to, annotated with colors, symbols, and/or patterns.

As can be appreciated, the heat map 200 can be viewed by the customer to determine whether or not to visit the various regions. The heat map 200 can be communicated to a mobile computing device of the customer prior to the customer reaching the retail location, or upon the customer entering the retail location. Furthermore, the heat map 200 can be displayed at one or more display devices located in the retail location to provide customers with an idea of which regions are currently crowded. Furthermore, the heat map 200 can be displayed on a screen 51 of the mobile computing device 50 possessed by the consumer.

Referring back to FIG. 2, the route optimization module 114 receives a request to create an optimized shopping route and an electronic shopping list from a mobile computing device and generates an optimized shopping route based thereon. An electronic shopping list contains one or more products, each product being indicative of an item sold at a retail location. The route optimization module 114 obtains a heat map corresponding to a retail location where a customer intends to purchase the items indicated in the electronic shopping list. The route optimization module 114 can determine the shopping route in any suitable manner. For example, the route optimization module 114 can determine the shopping route in the manner described in U.S. patent application Ser. No. (FILL IN THE SERIAL NUMBER OF VALERIE'S LAST APPLICATION, filed on ______, 2012), which is herein incorporated by reference. Furthermore, the route optimization module 114 can be configured to optimize the determined route, such that the route avoids regions that are heavily crowded. Similarly, the route optimization module 114 can optimize the route such that regions that are heavily crowded are visited at the end of the shopping route, so that the crowd size has time to decrease while the customer shops for the other items indicated in the electronic shopping list. The route optimization module 114 can optimize the shopping route in any other suitable manner.

The wait determination module 116 determines estimated wait times at specific regions in the retail location based on the crowd size at the specific region. The wait determination module 116 can receive the crowd size from the monitoring system 20. Further, the wait determination module 116 obtains a wait function from the location database 122. A wait function can be stored in the metadata corresponding to the retail location for which the wait time is being estimated. The wait function can be any function that is used to estimate the wait time. For example, if at the deli counter the average customer takes three minutes to help, but on average four customers are helped for every seven customers in the deli counter region, the wait function for the deli counter can be Wait Time=(4/7)*Crowd Size*3. It should be appreciated that the wait time functions can vary from region to region and from retail location to retail location. Once the wait time for a region is determined, the wait time can be annotated onto the heat map. In this way, the heat map can show how long a customer can expect to wait at a given department or at a checkout station.

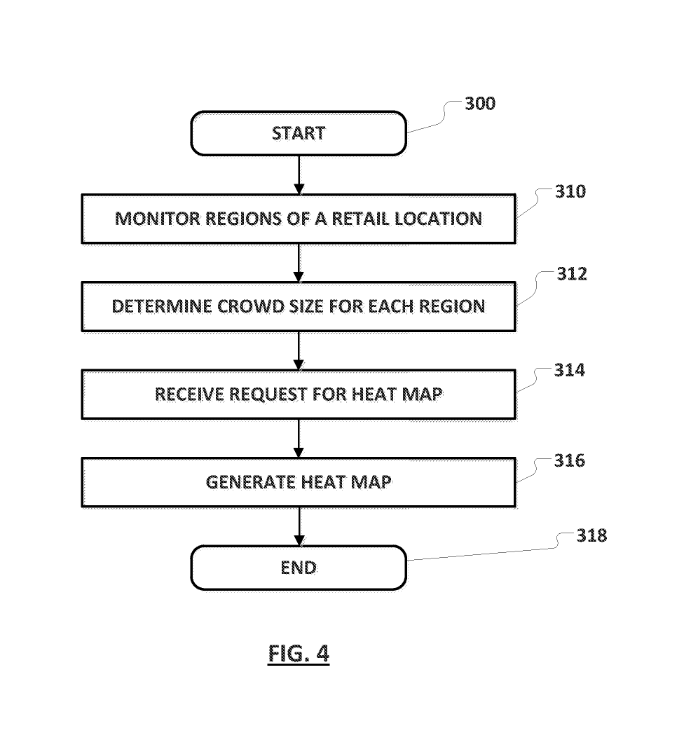

Referring now to FIG. 4, an example method 300 for providing a heat map to a mobile computing device is illustrated. The method 300 can be executed by the components illustrated in FIGS. 1 and 2.

At operation 310, the monitoring system 20 monitors the regions of a retail location. The monitoring system 20 can receive input from a plurality of sensors and/or a plurality of mobile computing devices. At operation 312, the monitoring system 20 determines crowd sizes for each of the regions in the retail location. As previously mentioned, the crowd sizes can be indicative of an amount of people in the region, a population density of the region, or a relative crowdedness of the region.

At operation 314, the heat map generation module 112 receives a request for a heat map for the retail location. The request may be received from a mobile computing device or from a process. At operation 316, the heat map generation module 112 generates the heat map. The heat map generation module 112 can retrieve a map of the retail location from the location database 122. Further, the heat map generation module 112 can receive the crowd sizes for each region of the retail location. For each region, the heat map generation module 112 can determine the relative crowdedness of the region based on the crowd sizes. For example, the heat map generation module 112 can compare the crowd sizes to crowd size thresholds. Based on the relative crowdedness of each region, the heat map generation module 112 can annotate the map of the retail location, thereby obtaining the heat map. The heat map can be stored in the memory device 120 or can be communicated to the requesting entity, e.g., mobile computing device or process. The exemplary process ends at 318.

The method 300 of FIG. 4 is provided for example only. Variations of the method 300 are contemplated and are within the scope of the disclosure. It is appreciated that not all of the operations are required and additional operations may be implemented.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer-implemented method comprising:
monitoring, at a processing device, a plurality of regions of a retail location;
determining, at the processing device, a plurality of crowd sizes based on the monitoring, each crowd size of the plurality of crowd sizes corresponding to one of the plurality of regions, each crowd size being indicative of an amount of people in its corresponding region at a given time; and
generating, at the processing device, a heat map based on the plurality of crowd sizes, the heat map being indicative of the amount of people in each of the regions.

2. The method of claim 1, further comprising:
determining, at the processing device, a shopping route of a user, the shopping route being indicative of a suggested path through the retail location for the user to follow when shopping for items indicated in an electronic shopping list, the items being indicative of products sold in the retail location;
optimizing, at the processing device, the shopping route based on the heat map; and
providing, at the processing device, the shopping route to a mobile computing device of the user.

3. The method of claim 2, wherein the shopping route is optimized to avoid regions in the retail location having crowd sizes that are greater than a crowd size threshold.

4. The method of claim 2, wherein the shopping route is optimized such that the shopping route travels through regions having relatively larger crowd sizes after regions having relatively smaller crowd sizes.

5. The method of claim 1, further comprising providing, at the processing device, the heat map to a mobile computing device of a user in response to a request for the heat map received from the mobile computing device.

6. The method of claim 1, wherein monitoring the retail location includes monitoring a sensor system interspersed throughout the retail location.

7. The method of claim 1, wherein monitoring the retail location includes monitoring locations of a plurality of mobile computing devices in the retail location.

8. The method of claim 1, further comprising determining an estimated wait time for at least one of the regions based on the crowd size of the region and a wait time function, the wait time function being specific to the region and the wait time being indicative of an amount of time a customer is likely to wait if the customer seeks service in the region.

9. The method of claim 1, wherein generating the heat map includes, for each region, determining a relative crowdedness of the region based on the crowd size and one or more crowd size thresholds corresponding to the region.

10. The method of claim 9, further comprising annotating the heat map based on the relative crowdedness of each region.

11. A system comprising:
a monitoring system that monitors a plurality of regions of a retail location and determines a plurality of crowd sizes, each crowd size of the plurality of crowd sizes corresponding to one of the plurality of regions, each crowd size being indicative of an amount of people in its corresponding region at a given time; and
a heat map generation module that generates a heat map based on the plurality of crowd sizes, the heat map being indicative of the amount of people in each of the regions.

12. The system of claim 11, further comprising a route optimization module that:
determines a shopping route of a user, the shopping route being indicative of a suggested path through the retail location for the user to follow when shopping for items indicated in an electronic shopping list, the items being indicative of products sold in the retail location;
optimizes the shopping route based on the heat map; and
provides the shopping route to a mobile computing device of the user.

13. The system of claim 12, wherein the route optimization module optimizes the shopping route to avoid regions in the retail location having crowd sizes that are greater than a crowd size threshold.

14. The system of claim 12, wherein the route optimization module optimizes the shopping route such that the shopping route travels through regions having relatively larger crowd sizes after regions having relatively smaller crowd sizes.

15. The system of claim 11, wherein the route optimization module provides the heat map to a mobile computing device of a user in response to a request for the heat map received from the mobile computing device.

16. The system of claim 11, wherein the monitoring system includes a sensor system interspersed throughout the retail location.

17. The system of claim 11, wherein the monitoring system monitors locations of a plurality of mobile computing devices in the retail location to determine the region of each mobile computing device at the given time.

18. The system of claim 11, further comprising a wait time determination module that determines an estimated wait time for at least one of the regions based on the crowd size of the region and a wait time function, the wait time function being specific to the region and the wait time being indicative of an amount of time a customer is likely to wait if the customer seeks service in the region.

19. The system of claim 11, wherein the heat map generation module is configured to determine a relative crowdedness of the region based on the crowd size of the region and one or more crowd size thresholds corresponding to the region.

20. The system of claim 19, wherein the heat map generation module annotates the heat map based on the relative crowdedness of each region.
